(19) United States
(12) Patent Application Publication
(10) Pub. No.: US 2024/0253984 A1
(43) Pub. Date: Aug. 1, 2024

(54) HEAT EXCHANGE REACTOR FOR CO2 SHIFT

(71) Applicant: Topsoe A/S, Kgs. Lyngby (DK)

(72) Inventors: Peter Mølgaard MORTENSEN, Roskilde (DK); Kim AASBERG-PETERSEN, Allerød (DK)

(73) Assignee: Topsoe A/S, Kgs. Lyngby (DK)

(21) Appl. No.: 18/562,999

(22) PCT Filed: Jun. 2, 2022
(86) PCT No.: PCT/EP2022/065069

§ 371 Date: Nov. 21, 2023

(30) Foreign Application Priority Data
Jun. 3, 2021 (EP) 21177658.8

(51) Int. Cl. C01B 3/16; C01B 3/38

(52) U.S. Cl. CPC C01B 3/16; C01B 3/38; C01B 2203/0811; C01B 2203/085; C01B 2203/0866; C01B 2203/0883; C01B 2203/1205; C01B 2203/1241; C01B 2203/1604; C01B 2203/1623; C01B 2203/1671

(57) ABSTRACT

A system and a process for CO₂ shift is provided. The system comprises a Reverse Water Gas Shift (RWGS) reactor, and a heat exchange reactor, HER. A first feed is converted in the RWGS reactor into a first product stream comprising CO. A second feed is arranged to be fed to a process side of the HER. At least a portion of the first product stream is arranged to be fed to a heating side of the HER such that heat from the first product stream is transferred to the process side of the HER, thereby allowing the conversion of the second feed to a second product stream comprising CO in the process side of the HER.

### TECHNICAL FIELD

The present technology relates to a system and a process for CO₂ shift. The system comprises a Reverse Water Gas Shift (RWGS) reactor, and a heat exchange reactor, HER. At least a portion of a first product stream from the RWGS reactor is arranged to be fed to a heating side of the HER such that heat from the first product stream is transferred to a process side of the HER, thereby allowing the conversion of a second feed to a second product stream comprising CO in the process side of the HER.

### BACKGROUND

Production of CO from CO₂ can be carried out by means of the reverse water gas shift reaction according to:

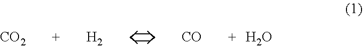

This is an endothermic reaction and consequently requires an energy input to proceed. Few industrial realizations of the technology actually exist, but on paper the reaction can be facilitated in a steam methane reformer (SMR)-like configuration where heat is supplied by external heating and the reaction is facilitated inside heated reactor zones or reactor tubes.

However, external heating typically means combustion of a hydrocarbon fuel and consequently often has an associated CO₂ emission which goes against the current interests of the chemical industry where-in recent years-focus has been on reducing greenhouse gas emissions. In principle the external heating could also be provided by hydrogen combustion where the hydrogen is supplied by electrolysis. However, this route will require substantial electric power for producing the hydrogen and this option is therefore expensive and not preferred.

The present technology aims to provide an effective system and method for production of CO from CO₂. In particular, in the present technology, the combustion of hydrocarbon fuels for heat should be reduced, or totally avoided, where possible. The present system and process provide a solution of two issues: increased heat utilization (i.e. lowered energy consumption) and increased robustness of the system/method.

CO rich synthesis gas streams are used for a variety of applications, including the production of methanol and synthetic fuels (e.g. jet fuel, kerosene, diesel, and/or gasoline) via for example the Fischer-Tropsch route.

WO2020/174057 discloses synthesis gas production by steam methane reforming.

Heat exchange reforming in connection with synthesis gas production from a natural gas-based feedstock is well known. In this case a heat exchange reformer is placed either in series or in parallel with a main steam reformer such as steam methane reformer and/or an autothermal reformer. A main issue in such schemes is metal dusting especially when synthesis gas stream with a high content of carbon monoxide is required. In the present invention, this issue is significantly reduced.

### SUMMARY

It has been found that the disadvantages of known systems/processes for CO₂ shift can be reduced, and even completely avoided using the system/process provided herein. Also, it has surprisingly been found that the using a HER type reactor for CO₂ shift in contrast to a heat exchange steam methane reformer is a much more robust solution. Also, the HER type reactor for CO₂ shift has been found to process significantly larger quantities of feedstock compared to a heat exchange steam methane reformer. Also, surprisingly the HER type reactor for CO₂ shift has been found to have a much lower risk of metal dusting compared to a heat exchange steam methane reformer.

In one embodiment, therefore a system for CO₂ shift is provided. The system comprises:
a first feed comprising CO₂ and H₂,
a second feed comprising CO₂ and H₂,
a Reverse Water Gas Shift (RWGS) reactor, and
a heat exchange reactor, HER having at least a process side and at least a heating side,

The first feed is arranged to be fed to the RWGS reactor and converted into a first product stream comprising CO. The second feed is arranged to be fed to the process side of the HER.

At least a portion of the first product stream is arranged to be fed to the heating side of the HER such that heat from the first product stream is transferred to the process side of the HER. Conversion of the second feed to a second product stream comprising CO in the process side of the HER is thereby allowed. A cooled first product stream results.

A process for CO₂ shift is also provided, in a system as described herein. The process comprises the steps of:
feeding the first feed to the RWGS reactor and converting it into a first product stream comprising CO;
feeding the second feed to a process side of the HER;
arranging at least a portion of the first product stream to be fed to a heating side of the HER such that heat from the first product stream is transferred to a process side of the HER, thereby allowing the conversion of the second feed to a second product stream comprising CO in the process side of the HER; thus providing a cooled first product stream.

Further details of the present technology are provided in the following description text, the figures and the dependent claims.

### LEGENDS

The technology is described with reference to the enclosed schematic figures, in which:

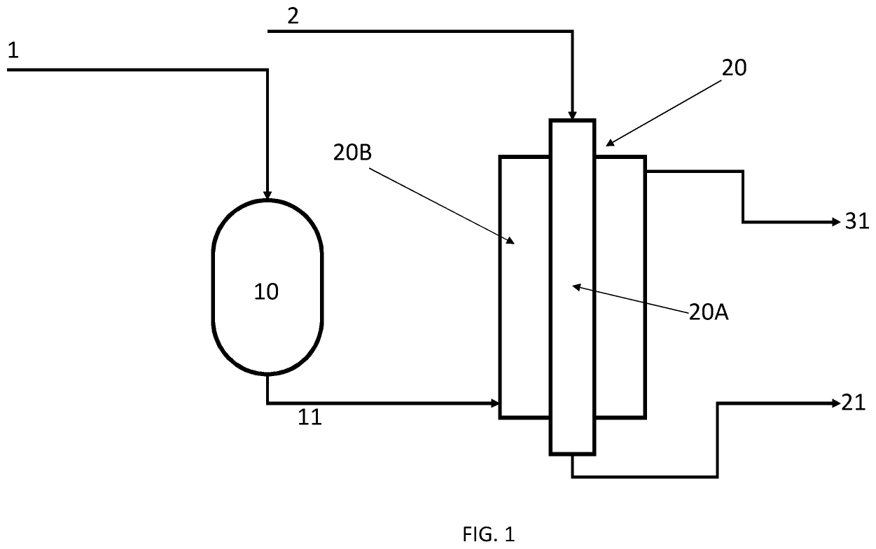

FIG. 1 shows a system according to the invention comprising, an electrical Reverse Water Gas Shift (e-RWGS) reactor and a heat exchange reactor (HER)

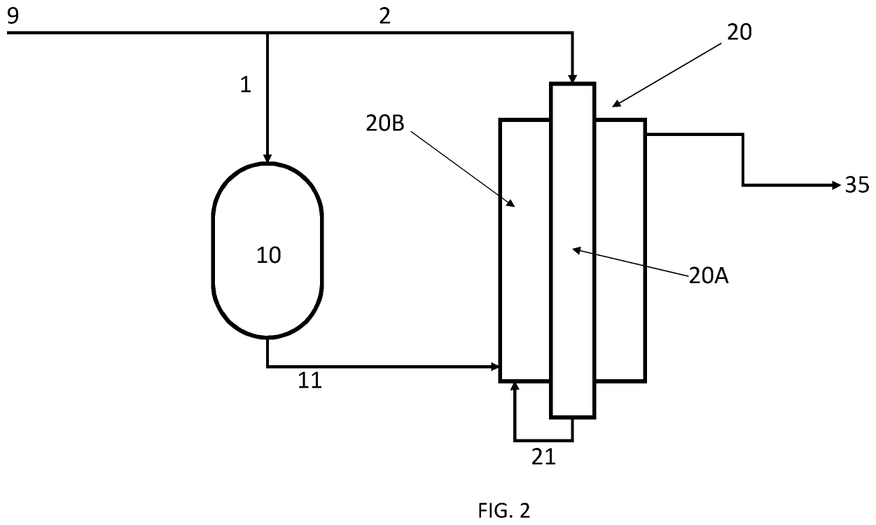

FIG. 2 shows a system similar to the system of FIG. 1, in which first and second feeds originate from a common feed.

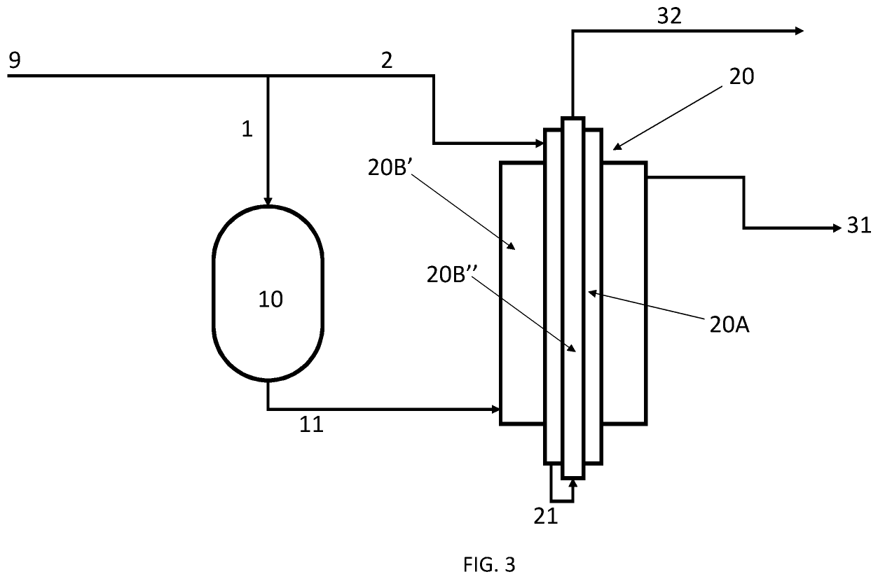

FIG. 3 shows a system similar to the system of FIG. 2, in which the HER has two separate heating sides.

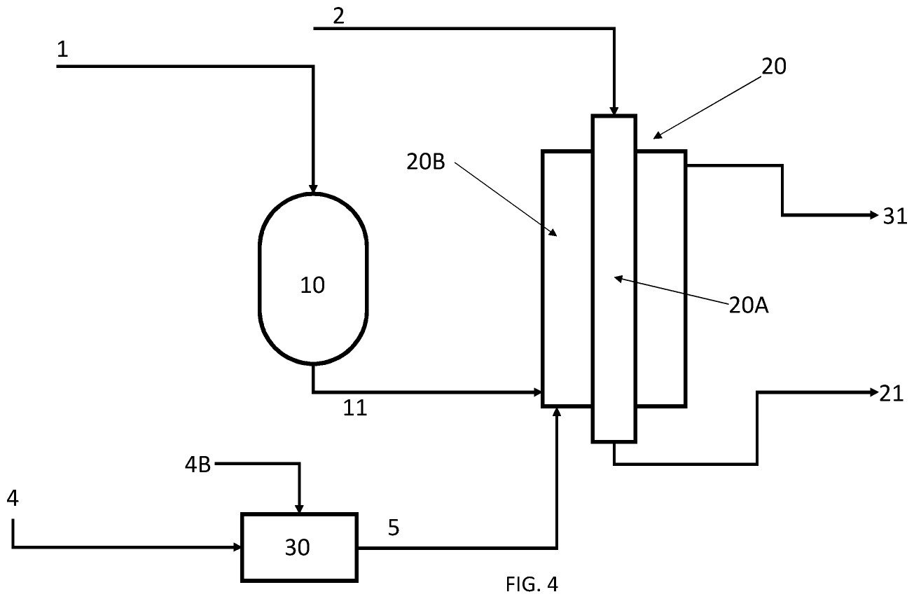

FIG. 4 shows a system according to the invention, further comprising a combustion unit.

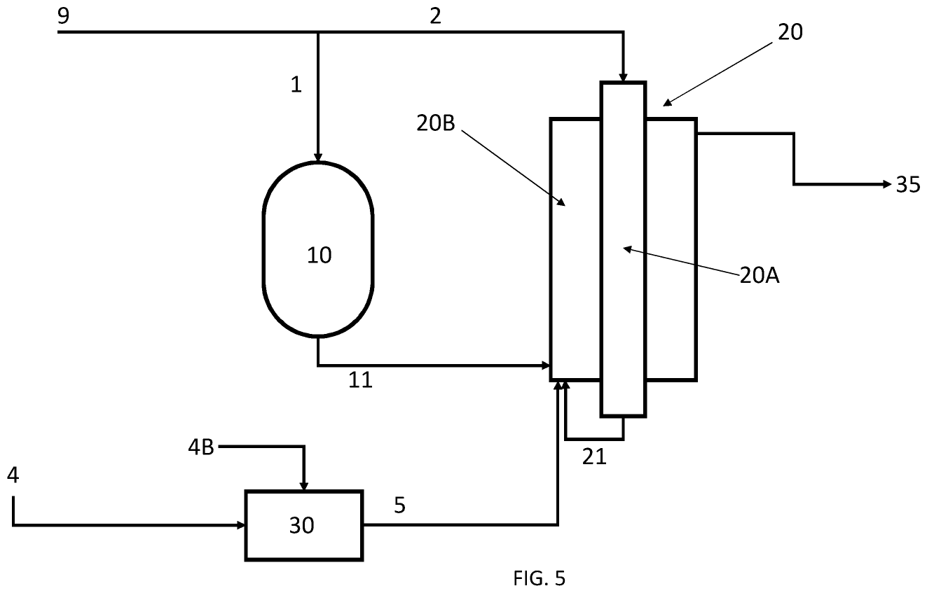

FIG. 5 shows a system similar to the system of FIG. 4, in which first and second feeds originate from a common feed.

FIG. 5A shows a system according to the invention, in which a flash separation unit is present to remove condensate

FIG. 5B shows a system similar to FIG. 5A

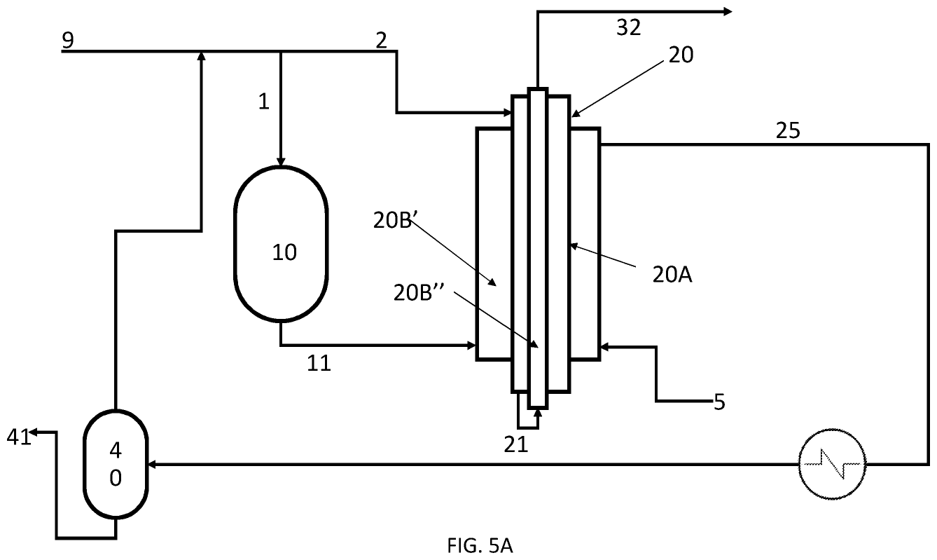

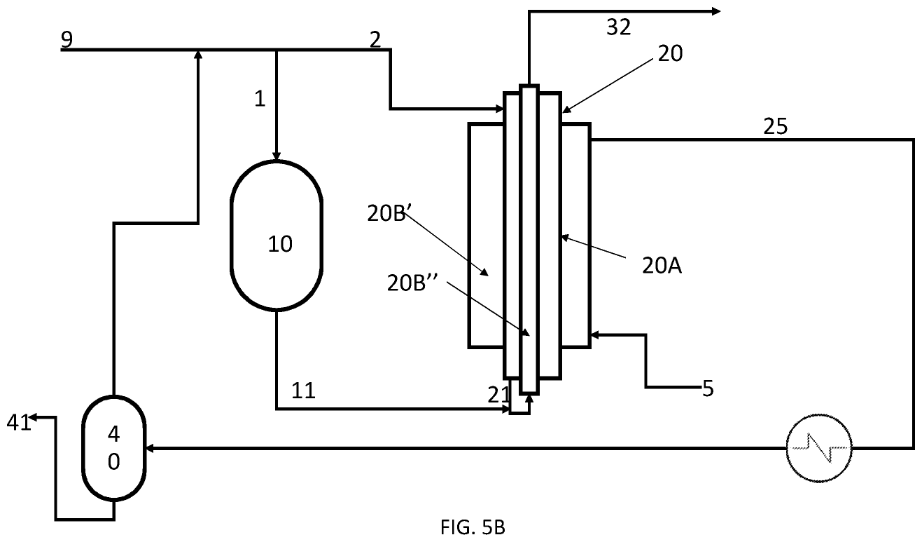

FIGS. 6-8 show temperature and actual gas carbon activity profile inside the HER for the examples 4, 5 and 6.

### DETAILED DISCLOSURE

Unless otherwise specified, any given percentages for gas content are % by volume.

The present technology describes how to produce synthesis gas from CO₂ and H₂ under reverse water gas shift reaction conditions.

The reverse water gas shift reaction is utilized (reaction (1) above). In an embodiment a catalyst able to catalyze only reaction (1) is utilized. This is referred to as a “selective catalyst”.

In another (preferred) embodiment, a catalyst able to catalyze both reaction (1) and the methanation reaction (2) below is utilized:

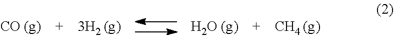

In this case the catalyst is termed “non-selective”.

Note that the selective catalyst is able to catalyze both the forward and backwards passes of reaction (1) and the non-selective catalyst in addition is able to catalyze both the forward and backwards of reaction (2). The non-selective catalyst is also able to catalyze other reactions such as for example the steam reforming of higher hydrocarbons (hydrocarbons with two or more carbon atoms such as ethane).

Typically, a catalyst with a catalytically active material comprising Nickel (Ni) or noble metals can be used as a non-selective catalyst.

The system comprises, in general terms:
a first feed comprising CO₂ and H₂,
a second feed comprising CO₂ and H₂,
a Reverse Water Gas Shift (RWGS) reactor, which is preferably an electrical Reverse Water Gas Shift (e-RWGS) reactor, and
a heat exchange reactor (HER) having at least a process side and at least a heating side.

The system may additionally comprise whichever additional units and connections (e.g. piping) the skilled person may consider necessary.

A first feed comprising CO₂ and H₂ is required in the system. This first feed may be or comprise a combustion product of another gas composition external to the system. Examples of CO₂ sources include flue gas or off-gas from CO₂ capture units such as amine wash units, biogenic CO₂, CO₂ from direct air capture units and/or CO₂ from cement or steel factories. Examples of H₂ sources include hydrogen produced from electrolysis (for example alkaline or Solid Oxide Electrolysis) or hydrogen produced from steam reforming.

Part of the first feed and/or the second feed may also comprise a recycle gas from a downstream unit. An example is the recycle of an off-gas (or tail gas) from a Fischer-Tropsch synthesis unit. Such a tail gas may be pre-treated before being used as part or all of the first and/or second feed. Another example is the purge gas from a methanol loop.

Suitably, the first feed comprises between 10-60% CO₂, such as e.g. between 20-35% CO₂, between 25-35% CO₂. Suitably, the first feed comprises between 40-90% H₂, such as e.g. between 50-80% H₂, between 60-70% H₂ or between 65-70% H₂.

In the first feed, the ratio between H₂ and CO₂ may be between 1-5, such as e.g. between 2-4, between 2-3 or between 2.2-2.5, or between 2.8-3.5, or between 2.8 and 3.2.

Suitably, the at least the main source of hydrogen in the first and second feeds is an electrolysis unit.

The first feed may in addition comprise other components such as CH4, N₂, Ar, O₂, CO, or H₂O. Other components such as other hydrocarbons including ethane are also conceivable typically in minor amounts.

The first feed suitably has the following composition (by volume):
50-80% H₂ (dry)
20-50% CO₂ (dry)

In an embodiment the first feed suitably has the following alternative composition by volume:
50-70% H₂
20-40% CO₂
2-10% CH₄
1-8% H₂O
0-5% CO
0-5% other components in total such as Ar, N₂, and ethane.

A second feed comprising CO₂ and H₂ is also required in the system. This second feed may be partly or completely a combustion product of another gas composition external to the system. Suitably, the second feed is identical to the first feed in terms of its gas composition.

In an embodiment, the second feed has a higher H₂/CO₂ ratio than the first feed. In specific embodiments the H₂/CO₂ ratio of the first feed is between 2-3.5, while the second feed has a H₂/CO₂ ratio of 2.5-4. This is an advantage in the case where the HER of the invention cannot reach the same degree of CO₂— conversion as the e-RWGS. In another embodiment process conditions including the H₂/CO₂ ratio in the first feed and the H₂/CO₂ of the second feed are adjusted such that the H₂/CO-ratio of the first product stream (RAT1) and the H₂/CO-ratio of the second product stream are similar i.e. 0.95<RAT1/RAT2<1.05 or preferably 0.98<RAT1/RAT2<1.02. This is an advantage as it simplifies process control and allows the plant to more easily continue running at reduced capacity if for example a trip of the HER occurs.

In one embodiment, the H₂/CO-ratio of the mixture of the first and second product streams is between 1.8 and 2.2 such as between 1.9 and 2.1. This is desirable for example if the synthesis gas is to be used for downstream synthesis of synthetic fuels such as kerosene or diesel by the Fischer-Tropsch synthesis.

In one embodiment, the (H₂—CO₂)/(CO+CO₂) ratio (also known as synthesis gas module) of the mixture of the first and second product streams is between 1.8 and 2.2 such as between 2.0 and 2.1. This is desirable for example if the synthesis gas is to be used for downstream synthesis of methanol.

In one aspect, the methane content in the first feed is higher than the methane content in the second feed, preferably wherein the molar content of methane in the second stream relative to the molar content of methane in the first feed is 0, or below 0.1 or below 0.5. This is an advantage because, in this way, the more endothermic reaction scheme is primarily facilitated in the RWGS reactor to allow a higher volume flow through the HER.

In one embodiment the molar concentration of steam in the second feed is higher than the molar concentration of steam in the first feed. This may be an advantage in the cases where the RWGS operates at same or similar pressure and the exit temperature of the HER is lower than the exit temperature from the RWGS reactor and when a non-selective catalyst is used. If the second feed contains a higher concentration of steam the methane concentration in the second product gas can be kept at a lower level than if the first and second feed streams have the same steam concentration.

In a further embodiment, the chemical composition (dry) of the first feed and the chemical composition (dry) of the second feed are identical while the steam content is higher in the second feed than in the first feed. Suitably, operating parameters can be adjusted such that either the H2/CO-ratio or the methanol module are “identical” in the outlet from the two reactors.

In a further embodiment, the molar ratio of CH₄/CO₂ in the first and second feeds is preferably less than 0.5, such as less than 0.2, preferably less than 0.1.

In a further embodiment, where the natural gas is preconditioned by desulfurisation and/or prereforming, the carbon from natural gas comprises less than 20, preferably less than 10%, more preferably less than 5% of the total amount of carbon in the first feed. In a further embodiment where the natural gas is preconditioned by desulfurisation and/or prereforming the carbon from natural gas comprises less than 20%, preferably less than 10%, more preferably less than 5% of the total amount of carbon in the second feed. In a further embodiment, where the natural gas is preconditioned by desulfurisation and/or prereforming, the carbon from natural gas comprises less than 20%, preferably less than 10%, more preferably less than 5% of the total amount of carbon in the first feed and second feeds combined.

In one aspect, the chemical composition of the first feed is the same as that of the second feed. Indeed, first and second feeds may originate from a single primary feed. Therefore, the system may comprise primary feed comprising CO₂ and H₂, wherein said primary feed is arranged to be divided into at least said first feed comprising CO₂ and H₂, and said second feed comprising CO₂ and H₂.

In a particular embodiment, the second feed has a temperature of 250° C. to 550° C., preferably from 260° C. to 450° C., preferably from 270° C. to 400° C., preferably from 280° C. to 380° C., preferably from 290° C. to 370° C., and most preferably from 300° C. to 360° C.

Part of the first feed and/or second feed may further originate from a hydrocarbon containing stream which has been prereformed upstream the RWGS and the HER reactors according to the following reaction:

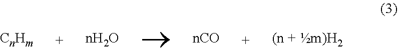

The above reaction is typically accompanied by the methanation reaction and the water gas shift reaction (reverse of reaction (1)) resulting in a mixture of mainly CO₂, H₂, CH₄, and steam.

An example of a hydrocarbon stream is a stream comprising paraffins such as ethane, propane, butanes, and/or pentanes. For paraffins, m=2n+2 in equation (3).

Another example of a hydrocarbon stream is LPG which is recycled from a synthesis section downstream the system of the invention, such as recycle from a Fischer-Tropsch synthesis unit or a unit producing hydrocarbons from methanol.

The first main component of the system is a Reverse Water Gas Shift (RWGS) reactor. The reverse water gas shift reaction proceeds according to reaction (1) above. The RWGS reaction (1) is an endothermic process which requires significant energy input for the desired conversion. High temperatures are needed to obtain sufficient conversion of carbon dioxide into carbon monoxide to make the process economically feasible.

The RWGS reactor may be selected from an electrical RWGS (e-RWGS) reactor, a fired RWGS reactor or an autothermal RWGS reactor, and is preferably an electrical RWGS (e-RWGS) reactor.

In one aspect, the RWGS reactor used for carrying out the reverse water-gas shift reaction between CO₂ and H₂ is an electrically-heated reverse water gas shift (e-RWGS) reactor. An e-RWGS reactor uses an electric resistance-heated reactor to perform a more efficient reverse water gas shift process and substantially reduces or preferably avoids the use of fossil fuels as a heat source. The e-RWGS reactor may comprise a catalyst that is either selective or non-selective. Preferably, the eRWGS reactor comprises a catalyst which is non-selective.

In an embodiment, the e-RWGS reactor suitably comprises:
a structured catalyst arranged for catalysing said RWGS reaction, said structured catalyst comprising a macroscopic structure of electrically conductive material, said macroscopic structure supporting a ceramic coating, wherein said ceramic coating supports a catalytically active material (for selective e-RWGS);
a structured catalyst comprising a macroscopic structure of electrically conductive material said macroscopic structure supporting a ceramic coating, wherein said ceramic coating supports a non-selective catalytically active material (for non-selective e-RWGS);
optionally a top layer, comprising a non-selective pellet catalyst,
a pressure shell housing said structured catalyst; said pressure shell comprising an inlet for letting in said feed and outlet for letting syngas product; wherein said inlet is positioned so that said feed enters said structured catalyst in a first end of said structured catalyst and said syngas product exits said structured catalyst from a second end of said structured catalyst;
a heat insulation layer between said structured catalyst and said pressure shell; and
at least two conductors electrically connected to said structured catalyst and to an electrical power supply placed outside said pressure shell, wherein said electrical power supply is dimensioned to heat at least part of said structured catalyst to a temperature of at least 500° C. by passing an electrical current through said macroscopic structure of electrically conductive material; wherein said at least two conductors are connected to the structured catalyst at a position on the structured catalyst closer to said first end of said structured catalyst than to said second end of said structured catalyst, and wherein the structured catalyst is constructed to direct an electrical current to run from one conductor substantially to the second end of the structured catalyst and return to a second of said at least two conductors.

The pressure shell suitably has a design pressure of between 2 and 50 bar. The pressure shell may also have a design pressure of between 50 and 200 bar. The at least two conductors are typically led through the pressure shell in a fitting so that the at least two conductors are electrically insulated from the pressure shell. The pressure shell may further comprise one or more inlets close to or in combination with at least one fitting in order to allow a cooling gas to flow over, around, close to, or inside at least one conductor within said pressure shell. The exit temperature of gas from the e-RWGS reactor is suitably 900° C. or more, preferably 1000° C. or more, even more preferably 1100° C. or more.

The eRWGS reactor may also be of a different design and/or the heat may be transferred by induction.

The eRWGS reactor may alternatively comprise a first heating end where the feed gas is heated by electrical heating to a high temperature such as 800-1000° C. and a second end comprising an (adiabatic) catalyst bed containing either a selective or non-selective catalyst, or a combination of catalysts.

In an embodiment, the RWGS reactor is a fired RWGS reactor. A fired RWGS reactor could consist of a number of tubes filled with catalyst pellets placed inside a furnace. The tubes are typically quite long, such as 10-13 meters, and will typically have a relative small inner diameter, such as between 80 and 160 mm, to collectively provide a high externally exposed surface area to facilitate heat transfer into the catalyst. The catalyst can be either a selective or non-selective catalyst, or a combination. The fired RWGS reactor requires a fuel gas. Burners placed in the furnace provide the required heat for the reactions by combustion of the fuel gas. There is a general limitation to the obtainable heat flux due to mechanical constraints and the capacity is therefore increased by increasing the number of tubes and the furnace size. This type of reactor configuration has been frequently used for steam reforming, where more details can be found in the art such as “Synthesis gas production for FT synthesis”; Chapter 4, p.258-352, 2004. Other types of fired RWGS reactors can also be envisaged.

In an embodiment, the RWGS reactor is an autothermal RWGS reactor or more preferably one or more pre-reactors followed by a downstream autothermal RWGS reactor.

In this case the first feed is directed to the (first) pre-reactor with non-selective catalyst in which reactions (1) and (2) take place. The effluent gas from the first pre-reactor may optionally be cooled and sent to the next pre-reactor in which the same reactions occur.

Further pre-reactors may be used. The pre-reactors are typically adiabatic or heated. The exit gas from the last pre-reactor is sent to an autothermal RWGS reactor.

The main elements of an autothermal RWGS reactor are a burner, a combustion chamber, and a catalyst bed contained within a refractory lined pressure shell. An autothermal RWGS reactor requires a feed of oxygen. In an autothermal RWGS reactor, partial combustion of the autothermal RWGS reactor feed by sub-stoichiometric amounts of oxygen is followed by reverse water gas shift and optionally also steam reforming of the partially combusted gas in a fixed bed of catalyst. Typically, the gas is at or close to equilibrium at the outlet of the reactor with respect to water gas shift and steam reforming reactions. The temperature of the exit gas is typically in the range between 850 and 1100° C. This type of reactor configuration has been frequently used for synthesis gas production from hydrocarbon feedstock, where more details can be found in the art such as “Studies in Surface Science and Catalysis, Vol. 152,” Synthesis gas production for FT synthesis”; Chapter 4, p.258-352, 2004”.

A fired RWGS reactor followed by an autothermal RWGS reactor may also be used. In this case the effluent from the RWGS reactor is directed to the autothermal RWGS reactor. The effluent gas from the fired RWGS reactor would in this case typically be between 700-900° C.

An electrical RWGS reactor followed by an autothermal RWGS reactor is also conceivable. The effluent gas from the electrical RWGS reactor would in this case typically be between 700-900° C.

The first feed, as described above, is arranged to be fed to the RWGS reactor and converted into a first product stream comprising CO.

The second main component of the system is a heat exchange reactor (HER). In connection with the present invention a HER is defined as a reactor, wherein a hot gas flowing in a heating side is used to supply heat by convection from the heating side across a wall to a process side, wherein a gas is flowing, and wherein the gas in the process side has a lower temperature than the hot gas in the heating side. An HER is configured to use a hot gas to supply the heat for the endothermic reaction by heat exchange, typically over a tube wall.

An example of a configuration of a heat exchange reformer has several parallel tubes filled with typically pellet catalyst which receive the feed gas. In the bottom of the reactor, the product gas from the catalyst filled tubes is mixed with hot synthesis gas from upstream reforming units and the combined synthesis gas carries out heat exchange with the catalyst filled tubes. Other configurations of heat exchange reactors are also conceivable.

The catalyst of the HER may be a selective catalyst active for CO₂ shift (RWGS) such as CuZn/Al₂O₃ or Fe₂O₃/Cr₂O₃/MgO or MnO/ZrO₂.

In a preferred embodiment, the catalyst of the HER is a non-selective catalyst. Examples of such catalysts include Ni/MgAl₂O₄, Ni/Al₂O₃, Ni/CaAl₂O₄, Nilr/MgAl₂O₄, Ni/ZrO₂, Ru/MgAl₂O₄, Rh/MgAl₂O₄, Ir/MgAl₂O₄, Ru/ZrO₂, Nilr/ZrO₂, Mo₂C, Wo₂C, CeO₂, a noble metal on an Al₂O₃. Other examples include active metals such as nickel, iridium, rhodium, and/or ruthenium on various forms of calcium aluminate.

The HER has at least a process side and at least a heating side. Process sides and heating sides are separated from one another by internal wall(s), such that fluid flow between the sides is not possible, but heat transfer from heating side to process side is possible. In one aspect, the HER may comprise two heating sides.

The process side of the HER is that side in which chemical reaction takes place. The process side of the HER may comprise one or more catalysts which promote a selected chemical reaction.

The heating side of the HER is not designed for chemical reactions to take place; instead, heat energy from hot fluid travelling through the heating side is transferred to the process side.

The HER may be a typical “shell and tube” heat exchange reactor, comprising a plurality of tubes located within a shell. There is a fluid connection between the interior of all tubes, but no fluid connection between interior and exterior of the tubes. In operation, one fluid flows through the interior of the tubes, while a second fluid flows in the shell, externally of the tubes. Heat is transferred from one fluid to the other, through the wall of the tubes. A manifold-type arrangement is located at each end of the bundle of tubes.

The HER will typically operate at a pressure close to the associated reactor, which in the present invention, is the RWGS reactor such as the e-RWGS.

The second feed (as described above) is arranged to be fed to the process side of the HER. In the process side, conversion of the second feed to a second product stream comprising CO takes place. This may occur either with a selective or a non-selective catalyst.

At least a portion—of and preferably the entirety of—the first product stream is arranged to be fed to the heating side of the HER in such a manner that heat from the first product stream is transferred to the process side of the HER. Thereby the conversion of the second feed to a second product stream comprising CO in the process side of the HER is allowed. At the same time, a cooled first product stream is provided.

Typically, the second product stream temperature will be in excess of 800° C., such as above 850° C., or above 900° C.

The current invention therefore describes a process where a heat exchange reactor is used as an integrated part of a plant for producing a gas comprising CO in a synergy with a RWGS reactor. By utilizing a first RWGS reactor for conversion of a first feed comprising CO₂ to CO by reaction with H₂, a first product stream is provided, which can be used a heating source for a second heat exchange reactor where a second feed comprising CO₂ can be converted into CO. The combination-of in particular-eRWGS and the heat exchange reactor gives a robustness to such a plant, as the eRWGS reactor (being dependent on electricity to run it) has a risk of shutting down in case of power failure or similar, while the heat exchange reformer does not provided that a different heat source is available.

Mixing means may be located downstream the HER, and arranged to combine cooled first product stream comprising CO with the (optionally cooled) second product stream comprising CO, so as to provide a third product stream comprising CO.

In one aspect, at least a portion of the second product stream is arranged to be fed to the heating side of the HER, either as a separate stream, or in admixture with the first product stream to provide a second cooled product stream (if fed separately to the first product stream), or a third product stream (i.e. a combination of first and second product streams). In this way increased heat recovery can be achieved and an energy efficient plant design realized.

In this aspect, the HER may have two separate heating sides, where the second product stream is fed to a separate heating side than that of the first product stream. Such an HER is illustrated in FIG. 3.

In a further aspect, at least a portion of the second product stream is arranged to be fed to the heating side of the HER, in admixture with the first product stream, and whereby said HER is arranged to output a third product stream from the heating side thereof.

This arrangement is advantageously used in the case where both the first and second product streams are to be used for the same downstream application, wherefore mixing just as well can be done in the HER to in this way maximize utilization of heat transfer area in the equipment.

In a specific embodiment, the HER comprises a number of double tubes. Double tubes are understood as two concentric tubes with similar length where the inner tube has a smaller diameter than the outer tube. In this arrangement, catalyst is placed both in the inner tubes and between the outer tubes. Part of the second feed gas flows from the HER reactor inlet through the catalyst filled inner tubes to the other end of the HER reactor. The remaining part of the second feed gas flows through the catalyst filled areas between the outer tubes. The second product gas consisting of the gas leaving the catalyst filled inner tubes and the catalyst filled areas between the outer tubes are mixed with the first product gas yielding a third product gas. The third product gas flows in essentially countercurrent mode through the annular space between the inner and outer tubes yielding a cooled third product gas. The cooling of the third product gas provides the required heat for the process sides (the catalyst filled inner tubes and the area between the outer tubes). This is an example of a system in which the HER has two process sides.

In a further embodiment the third product stream is further cooled in a heat exchanger (waste heat boiler) in which the heat is used to generate steam from a stream of water. This further cooled third product stream will typically have a temperature of 300-550° C. The produced steam can be used for a variety of purposes such as being part of the first and/or second feed, used for electricity production or as feed stream for an electrolysis unit for producing hydrogen. In this case the electrolysis unit can be arranged in series with the eRWGS and/or the HER reactor. The hydrogen produced in the electrolysis unit can be added directly to the eRWGS and/or the HER reactors as part or all of the hydrogen in the first and/or second feed.

The further cooled third product stream may have a temperature of 300-550° C. after being used for steam generation as described above. This further cooled third product stream can subsequently also be used for additional heating such as for example preheating of part or all of the first and/or second feed streams. Even if the further cooled third product stream has a high content of carbon monoxide, severe metal dusting can be avoided as the temperature of the heat transfer surfaces is sufficiently low.

If the cooled first and second product streams are not or only partially mixed, a similar arrangement may take place with one or both of the streams.

The third product stream may be used as heat source for example for preheating part or all of the first and/or second feed. This has the advantage of optimizing the energy efficiency. A similar arrangement may take place with the cooled first and/or second streams.

The preheating of the first and/or second stream and the generation of steam may take place either in parallel or in series.

The system may include a specific HER. In this aspect, the process side of the HER comprises a process side inlet (through which second feed enters the HER) and a process side outlet (through which second product stream exits the HER). A first reaction zone (I) is disposed closest to the process side inlet, and a second reaction zone (II) is disposed closest to the process side outlet.

In this HER aspect, the first reaction zone (I) is arranged to carry out an overall exothermic reaction of the second feed, wherein the overall exothermic reaction comprises at least the following reactions, which have a net progress from left to right:

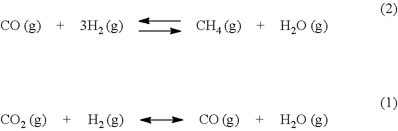

Both of these reactions take place in the first reaction zone (I).

In this HER aspect, the second reaction zone (II) is arranged to carry out an overall endothermic reaction, wherein the overall endothermic reaction comprises at least the following reactions, which have a net progress from left to right:

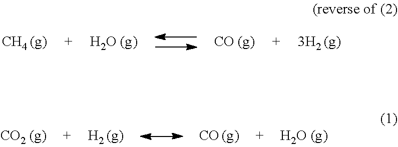

Typically, both the RWGS/Water gas shift reaction and the steam reforming/methanation reactions are at or close to chemical equilibrium at the outlet of the reactor. Specifically, a non-selective catalyst is used in this aspect.

In one aspect, the process side of the HER has a total length extending from the process side inlet to the process side outlet, and wherein the first reaction zone (I) has an extension of less than 50%, such as less than 30%, preferably less than 20%, more preferably less than 10% of the total length of the process side of the HER. A first catalyst may be located at least in the first reaction zone (1), and may extend at least partly into the second reaction zone (II).

In another embodiment the same type of non-selective catalyst is used both in the first and second reaction zones.

Suitably, at least the end of the first reaction zone (1) which is located closest to the process side inlet of the HER is not directly in contact with the heating side of the HER, so that this end of the first reaction zone (1) is primarily heated by the adiabatic temperature rise caused by said exothermic reaction. The process side inlet of the HER is the end of the HER where the second feed gas enters. The said end of the process side of the first reaction zone (1), which is not directly in contact with the heating side of the HER, may be an end section, which has an extension of up to 25% of the total extension of the process side of the first reaction zone (1) in the direction from the process side inlet towards the process side outlet. In particular, said end section has an extension of 5-20%, preferably 5-10%, of the total extension of the process side of the first reaction zone in the direction from the process side inlet towards the process side outlet.

It is essential to avoid carbon formation on the catalyst both in the HER reactor and in the fired or electrical RWGS reactor. Furthermore, it is well known that a risk of metal dusting exists when gases comprising CO are produced, and especially when such gases are cooled. The present invention avoids, or substantially reduces, the risk of both carbon formation and metal dusting in the HER reactor.

Metal dusting may occur on metallic walls in the presence of gases comprising CO. The chemical reaction leading to metal dusting is often one of the following:

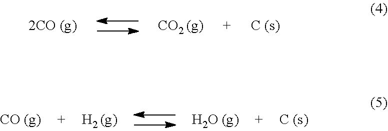

The first reaction is known as the Boudouard reaction and the second as the CO reduction reaction. Metal dusting may in severe cases lead to rapid degradation of metallic walls and result in severe equipment failure.

As a central part of the invention, the use of a non-selective catalyst is preferred to using a selective catalyst for several reasons as will be explained in the following: When using a non-selective catalyst in the first reaction zone (I), methanation takes place in addition to the RWGS reaction. This results in release of chemical energy to heat the system and a resulting temperature increase as the methanation is exothermic. As the CO reduction reaction is also exothermic, the increase in temperature created by the methanation reaction results in a reduction of the potential for the CO reduction reaction and when the temperature has risen to a certain level, no potential for the CO reduction reaction will be present at all. This exact level will be dependent on the specific reactant concentration, inlet temperature, and pressure, but will typically be in the range from 500-800° C. above which the CO reduction reaction will not have a potential to take place. Notice, that the exotherm generated by the methanation reaction will give the highest temperature rise at the active site of the catalysts on the surface of the structured catalyst which is also the place where carbon formation can take place. Consequently, this exotherm has a pronounced positive effect for reducing the carbon formation potential on the catalyst.

Overall, the configuration of this HER allows for facilitating the reverse water gas shift reaction and the methanation reaction within a reactor system without having a side-reaction of carbon formation on the catalyst or the metallic surfaces, as the methanation reaction counterintuitively mitigates this. The specific configuration of the reactor system which allows for increasing the temperature from a relative low inlet temperature to a very high product gas temperature of more than 500° C., preferably more than 800° C., and even more preferably more than 900° C. or 1000° C. means that the resulting methane formed from the methanation reaction will occur in the first reaction zone (1) of the HER reactor, but when exceeding ca. 600-800° C. this methane will start to be converted by the reverse methanation reaction back to a product rich in CO. This configuration elegantly allows for removing some of the CO and generation of some H₂O inside the catalyst bed in the temperature region where CO reduction is a problem, but then allows for reproducing the CO in the high temperature zone with low or no carbon potential. Effectively, utilizing the high product gas temperature means that the final product can be delivered with a very low methane concentration, despite the methane having a peak concentration somewhere along the reaction zone. In an embodiment, the reactor system is operated with none, or very little, methane in the feed and only very little methane in the product gas, but with a peak in methane concentration inside the reaction zone higher than in the feed and/or product gas. In some cases, this peak methane concentration inside the reaction zone may be an order of magnitude higher than the inlet and outlet methane concentrations.

The use of a non-selective catalyst also has the benefit that small amounts of methane or other hydrocarbons can be converted into synthesis gas in the HER.

As indicated above, the CO-concentration and the potential for carbon formation is low when using a non-selective catalyst. Assuming that the gas in the process side of the HER reactor is in equilibrium with respect to reactions (1) and (2), there will typically be no thermodynamic potential for carbon formation by either of reactions (4) and (5). If a selective catalyst is used and only reaction (1) takes place (i.e. reaction (2) does not take place), the CO concentration will be significantly higher. In this case there will typically be thermodynamic potential for carbon formation from both reactions (4) and (5) and, hence, the risk of carbon formation is substantially higher.

The above arguments for using a non-selective catalyst in the HER reactor also applies for using a non-selective catalyst in the electrical or fired RWGS reactors.

In one aspect, the system may further comprise a combustion unit and a third feed of fuel, wherein said third feed of fuel is arranged to be fed to the combustion unit and combusted therein in the presence of an oxidant to provide a fifth feed of combusted gas, wherein said fifth feed is arranged to be fed to the heating side of the HER, alone or in admixture with said first and/or said second product streams. Preferably, the oxidant in said combustion unit is substantially pure oxygen, preferably more than 90% oxygen, most preferably more than 99% oxygen. This allows the option of keeping the HER operating while it is not directly linked to the RWGS or alternatively to boost the transferred duty of the HER to thereby facilitate increased CO production in the second product stream.

The third feed of fuel may be a feed comprising hydrogen, which is combusted to a fifth feed, being a feed comprising steam. Having substantially pure steam as the fifth feed is advantageous when this is mixed to either the first and/or second product stream, because the steam easily is removed again and thereby will not influence the product quality of the produced synthesis gas.

Alternatively, the third feed of fuel may be a feed comprising methane and/or other hydrocarbons, such that the fifth feed is a feed comprising carbon dioxide and steam. CO₂ can in this way advantageously be recovered from downstream the HER and be used as input to the first and/or second feedstock. In an embodiment, the external burner is running substochiometric and the fifth feed could comprise CH₄, CO, and/or H₂. In particular, it is of interest if H₂ is substoichiometric with respect to O₂.

When the 5^{th} feed is fed separately to the heating side of the HER, as above, the cooled fifth feed may be used downstream the HER as part of said first feed comprising CO₂ and H₂ and/or as part of said second feed comprising CO₂ and H₂. Cooling of this feed may result in condensation of part of the steam therein.

Typically, the cooled fifth feed will be cooled sufficiently to condense H₂O before being sent to the feed side (cf. FIG. 5). The system may therefore include an optional condensation stage.

In a particular aspect of the system, wherein the RWGS reactor is an electrical Reverse Water Gas Shift (e-RWGS) reactor or a fired RWGS reactor, the HER is suitably arranged to produce more than 20%, more than 30%, or more than 40%, or more than 50% or more than 60% of the total combined CO produced by the RWGS reactor and the HER.

In a further aspect of the system, wherein the RWGS reactor is an electrical Reverse Water Gas Shift (e-RWGS) reactor or a fired RWGS reactor and wherein the system is arranged such that the molar flow of the second feed constitutes more than 20%, more than 30%, or more than 40%, or more than 50% or more than 60% of the total combined molar flow of the first and second feeds.

In a further aspect of the system, wherein the RWGS reactor is an electrical Reverse Water Gas Shift (e-RWGS) reactor or a fired RWGS reactor and wherein the system is arranged such that the molar flow of the CO₂ in the second feed constitutes more than 20%, more than 30%, or more than 40%, or more than 50% or more than 60% of the total combined molar flow of the CO₂ in the first and second feeds.

The RWGS reactor and the HER of the system of the invention is in parallel configuration, which means that the first product stream is not fed to the process side of the HER and that the second product stream is not fed to the process side of the RWGS.

The system of the present invention provides a layout configuration comprising a RWGS reactor and a HER I parallel configuration. Such a configuration has provided a possibility of increasing the production capacity of the plant as compared to a standalone RWGS reactor and a RWGS reactor and a HER in serial configuration. Furthermore, such a parallel configuration has provided a possibility of producing an output product stream from the system in the form of combined first and second product streams, wherein the composition of the combined product stream may be selected over a very wide range of compositions. Thus, the RWGS reactor may for example be used to produce a basic product gas with a selected molar composition, and the HER may then be used to produce a product gas with a different molar composition, which can be used to adjust the molar composition of the combined product stream to a selected composition. The system may be controlled in a simple manner, e.g. by controlling the quantity and composition of the second feed to the HER. Thus, the invention has provided a system of with a high degree of flexibility in respect to the composition of the product stream.

Also, the parallel configuration of the RWGS reactor and the HER has provided a possibility of adjusting the temperature of the combined product gas from the system, as the temperature of the second product gas from the HER is lower than that of the first product gas from the RWGS. A lower temperature of the product gas from the system is desirable, as it facilitates the downstream heat management.

Furthermore, the parallel configuration of the RWGS reactor and the HER has provided a possibility of using the heat contained in the hot first product stream from the RWGS reactor as a means for heating in the HER hence improving the energy efficiency of the system, specifically the energy consumption per cubic meter of produced product gas. It is a realization of the invention that a marked reduction in energy consumption can be achieved by having the parallel configuration of the RWGS reactor and the HER.

The present invention also provides a process for CO₂ shift, in a system comprising:
a first feed comprising CO₂ and H₂,
a second feed comprising CO₂ and H₂,
a Reverse Water Gas Shift (RWGS) reactor, which is preferably an electrical Reverse Water Gas Shift (e-RWGS) reactor, and
a heat exchange reactor, HER, having at least a process side and at least a heating side.

The process comprises the steps of:
feeding the first feed comprising CO₂ and H₂ to the RWGS reactor and converting it into a first product stream comprising CO;
feeding the second feed comprising CO₂ and H₂ to the process side of the HER;
arranging at least a portion of the first product stream to be fed to the heating side of the HER such that heat from the first product stream is transferred to the process side of the HER, thereby allowing the conversion of the second feed to a second product stream comprising CO in the process side of the HER; thus providing a cooled first product stream

In this process, the RWGS reactor may be selected from an electrical Reverse Water Gas Shift (e-RWGS) reactor, a fired RWGS reactor or an autothermal RWGS reactor. A fired RWGS reactor followed by an autothermal RWGS reactor may also be used. In this case the effluent from the RWGS reactor is directed to the autothermal RWGS reactor. The effluent gas from the fired RWGS reactor would in this case typically be between 700-900° C.

An electrical RWGS reactor followed by an autothermal RWGS reactor is also conceivable. The effluent gas from the electrical RWGS reactor would in this case typically be between 700-900° C.

Suitably, when the RWGS reactor is an electrical Reverse Water Gas Shift (e-RWGS) reactor or a fired RWGS reactor then more than 20%, more than 30%, or more than 40%, or more than 50% or more than 60% of the total combined duty from the RWGS reactor and the HER can be placed in the HER. Furthermore, when the RWGS reactor is an electrical Reverse Water Gas Shift (e-RWGS) reactor or a fired RWGS reactor, the HER produces more than 20%, more than 30%, or more than 40%, or more than 50% or more than 60% of the total combined CO produced by the RWGS reactor and the HER.

In a further aspect, where the RWGS reactor is an electrical Reverse Water Gas Shift (e-RWGS) reactor or a fired RWGS reactor, the molar flow of the second feed constitutes more than 20%, more than 30%, or more than 40%, or more than 50% or more than 60% of the total combined molar flow of the first and second feeds.

Suitably, the molar carbon flow of the second feed may constitute more than 20%, more than 30%, or more than 40%, or more than 50% or more than 60% of the total combined molar carbon flow of the first and second feeds.

In a particular aspect of the process, wherein the RWGS reactor is an electrical Reverse Water Gas Shift (e-RWGS) reactor or a fired RWGS reactor, the CO produced in the HER is more than 20%, more than 30%, or more than 40%, or more than 50% or more than 60% compared to the CO produced in the RWGS reactor.

In a further aspect of the process, wherein the RWGS reactor is an electrical Reverse Water Gas Shift (e-RWGS) reactor or a fired RWGS reactor and the molar flow of the CO₂ in the second feed constitutes more than 20%, more than 30%, or more than 40%, or more than 50% or more than 60% of the total combined molar flow of the CO₂ in the first and second feeds.

The operating conditions of the HER may be designed to provide a temperature of the cooled first product stream and/or the cooled second product stream and/or the cooled third product stream, at the outlet of the HER which is higher than the critical limit for metal dusting. This means that the temperature is high enough such that either there is no thermodynamic potential for metal dusting or that the thermodynamic potential is low enough such that either metal dusting does not occur or occurs at a very low rate.

When handling CO-containing gases at elevated temperatures, carbon formation through the so-called metal dusting phenomenon must be considered. The central carbon forming reactions to consider are the Boudouard reaction and CO reduction reactions described above.

Both reactions are exothermic and are consequently favored at lower temperatures.

A measure to evaluate the risk of carbon formation is the carbon activity (a_{c}) according to:

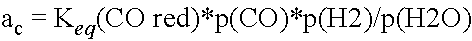

Where K_{eq}(CO red) is the thermodynamic equilibrium constant of the CO reduction reaction at a given temperature, and p(i) is the partial pressure of i. Notice than when a_{c}<1 carbon formation cannot take place. The temperature at which a_{c}=1 is known as the Carbon Monoxide Reduction Temperature, T_{co}.

A similar expression can be made for the Boudouard reaction. The temperature at which a_{c}=1 for the Boudouard reaction is known as the Boudouard Temperature, T_{B}.

In one aspect, the exit temperature of the cooled first product stream and/or cooled second product stream and/or the cooled third product stream is 500° C. or higher, 600° C. or higher, 700° C. or higher, or 800° C. or higher. By controlling the cooled product stream temperature, the risk of metal dusting can be controlled, where in general lower temperatures favours increased (and unwanted) potential (higher a_{c}) towards metal dusting due to the exothermic nature of the associated reactions.

The control of the temperature can be made by proper design of the HER reactor. One way of accomplishing this is to minimize or eliminate the transfer of heat from the heating side to the process side in reaction zone (I). As described above in a preferred embodiment most or all of the temperature increase in reaction zone (I) is caused by the adiabatic temperature increase due to the methanation reaction when a non-selective catalyst is used. In a preferred embodiment, the temperature of the gas leaving the first reaction zone (I) is above 650° C., more preferably above 700° C., and most preferably above 750° C. The temperature of the gas leaving the HER reactor from the heating side must be above the temperature of the of the gas leaving reaction zone (I) on the process side if no heat transfer between the process side and the heating side take place in reaction zone (I). Hence, one means to maintain a high temperature of the gas (e.g. cooled first product gas) leaving the HER reactor from the heating side is to prevent or minimize heat transfer in the HER reactor in reaction zone (I). This can for example be done by:
1) Install an adiabatic non-selective catalyst upstream the HER reactor as described above;
2) Most or all of the first reaction zone (1) are not in direct heat contact with the heating side in/of the HER.
3) Means such as insulation are provided in part of the HER reactor between the process side and the heating side at least in part of reaction zone (1).

In one embodiment according to 1) or 2) above, the second feed reacts adiabatically according to reactions (1) and (2) at (or close to) equilibrium.

In most applications in plants for producing CO-rich gases (e.g. a gas with a content of at least 20% dry CO), the use of heat exchange type reactors is not possible due to metal dusting. However, according to the present invention, the use of the HER reactor is possible without detrimental metal dusting while still increasing the plant efficiency. The use of the HER reactor reduces the power used in the e-RWGS reactor compared to a situation with a stand-alone e-RWGS reactor.

The cooled first product stream and/or the cooled second product stream and/or the cooled third product stream at the cooled exit temperature from the HER suitably has a CO reduction reaction actual gas carbon activity lower than 100, or lower than 50, or lower than 10, or lower than 5, or lower than 1. In the preferred embodiment where the HER has an exothermic first reaction zone (1), the associated temperature rise elegantly increases the temperature on the process side to such an extent that a minimum temperature of the cooled product gas is established, which consequently limits carbon activity (a_{c}) of the CO reduction reaction to 20, or even 10 in some embodiments.

In one embodiment the temperature of the cooled first product stream and/or the cooled second product stream and/or the cooled third product stream is less than 150° C., preferably less than 100° C. or less than 50° C. lower than the Boudouard temperature and/or the CO-reduction temperature.

In one aspect, the H2/CO ratio of the first product gas, the second product gas, and/or the third cooled product stream is in the range from 0.5 to 3.0, such as in the range 1.9-2.1, or in the range 2-3. Furthermore, the (H2−CO2)/(CO+CO2) ratio of the first product gas, the second product gas, and/or the third cooled product stream may be in the range from 1.5 to 2.5, such as in the range 1.9-2.1, or in the range 2-2.05.

It is recognized that the potential for metal dusting should in reality be evaluated at the temperature of the HER wall near the outlet of the HER. However, the difference between the conditions at the wall of the HER will depend upon the HER design and will be close to the conditions of the gas outlet conditions (temperature, pressure, gas composition)

As described above, the HER reactor may comprise a first reaction zone (I) in which methanation and RWGS primarily takes place and a second reaction zone (II) in which steam reforming and RWGS primarily occurs. As described above in a preferred embodiment most or all of the temperature increase is caused by the adiabatic temperature increase due to the methanation reaction. In a preferred embodiment, the temperature of the gas leaving the first reaction zone (I) is above 650° C., more preferably above 700° C.

In one aspect of the process of the invention a third feed of fuel is arranged to be fed to a combustion unit and combusted therein in the presence of an oxidant to provide a fifth feed of combusted gas, wherein said fifth feed is arranged to be fed to the heating side of the HER, alone or in admixture with said first and/or said second product streams.

The process above can be heated by the first product stream, or by the fifth feed (resulting from combustion of the third feed comprising fuel). Therefore—in a first operating mode A of said process—the HER is heated primarily by said first product stream and—in a second operating mode B of said process—the HER is heated primarily by said fifth feed. If the HER is heated “primarily” by a given feed or stream, it is meant that at least 50% of the transferred duty can be traced back to said feed or stream.

The process can comprise the step of switching between first operating mode A and said second operating mode B, or vice versa, as required by user preference, or the availability of various heating sources. For instance, when the RWGS reactor is an electrical Reverse Water Gas Shift (e-RWGS) reactor, the step of switching from first operating mode A to second operating mode B may involve reducing the electrical load to the electrical Reverse Water Gas Shift (e-RWGS) reactor. This reduces conversion of the first feed in the e-RWGS reactor, reducing the availability of first product stream for heating the HER in operating mode A. Overall production of CO for downstream application is however, at least partly, maintained by maintain or increasing the duty to the HER through the combustion process.

Also, the step of switching from second operating mode B to first operating mode A may involves increasing the electrical load to said electrical Reverse Water Gas Shift (e-RWGS) reactor. This increases conversion of the first feed in the e-RWGS reactor, increasing the availability of first product stream for heating the HER in operating mode A.

The change from operating mode A to B or vice versa may correlate with the availability of electricity such as renewable electricity. Switching between these two modes makes continuous operation of the plant possible despite variable availability of electricity, and even allows methods to have minimal impact on CO production for downstream application(s).

This is an advantageous operation mode to have available in cases where drop in (renewable) electricity availability otherwise would have forced a plant according to the invention to shut down. By keeping the plant operating by the method of the invention the plant can also swiftly be returned to full load operation, and maximal plant throughput can be obtained without shut-down of downstream processes.

All features of the system of the invention described above can be included in the process of the invention, in so far as they are relevant.

The invention also provides a method for starting up the process described herein in the case where the RWGS reactor is an electrical Reverse Water Gas Shift (e-RWGS) reactor, said method comprising the steps of:
a) introducing said first feed comprising CO₂ and H₂, to said e-RWGS reactor and converting it into a first product stream comprising CO; and allowing said at least a portion of the first product stream to be fed to the heating side of the HER;
b) increasing the temperature of said first product stream by increasing the electrical power to said e-RWGS reactor;
c) feeding said second feed comprising CO₂ and H₂, to the process side of the HER

In this method, steps b and c are carried out after step a. Preferably, step c) may be carried out after step b.) However, as an alternative, step b) may be carried out after step c). Step c) is suitably performed over a time period of 5 hours, preferably 1 hour, and even more preferably 30 min.

Consequently, the configuration allows for a plant where in a fail-safe mode the production from the plant can be maintained by making heating gas from another source in the case where the e-RWGS cannot provide, or even to increase start-up time. A specific embodiment could be to “fuel” the heat exchange reformer by having an externally combusted H₂ as fuel to the plant, where the resulting hot steam is used a heat source for the heat exchange reactor.

The configuration of the e-RWGS reactor combined with a heat exchange reactor enables reduced energy input for converting CO₂ into CO, over e.g. a standalone RWGS unit. In the order of 20-40% electrical energy input can typically be saved, but in some instances 40-60%. Additionally, the constellation allows for building in increased robustness of such a plant by having a back-up combustion station for providing high temperature process gas to heat the process in the case where the electrically heated operation cannot be operated, such as in the case of a power outage.

The syngas produced by the system and the process above may be used for instance for producing methanol, synthetic gasoline, synthetic jet fuel or synthetic diesel.

### Specific Embodiments

FIG. 1 shows a general embodiment of a system 100 of the invention. First feed 1 comprising CO₂ and H₂ is fed to Reverse Water Gas Shift (RWGS) reactor 10, where it is also converted into a first product stream 11; i.e. a syngas stream. The outlet temperature of the RWGS reactor (i.e. the first product stream 11) is >1000° C. Second feed 2 is fed to process side 20A of the HER 20 and converted therein to second product stream 21 (also a syngas stream). The HER is operated with an outlet temperature (i.e. the second product stream 21) of 950° C. The first product stream 11 is fed to the heating side 20B of the HER such that heat from the first product stream 11 is transferred to the process side 20A of the HER 20. Conversion of the second feed 2 to a second product stream 21 comprising CO in the process side 20A of the HER 20 is thus promoted; and a cooled first product stream is provided. The exit temperature of the cooled first product stream 31 from the HER is ca. 500° C. or higher.

FIG. 2 shows an embodiment of a system 100 similar to that of FIG. 1, in which reference numbers are as in FIG. 1. Additionally, for this system, a primary feed 9 comprising CO₂ and H₂ is divided into the first feed 1 and second feed 2. The primary feed has a feed rate of 10000 Nm³/h and contains around 70% H2 and 30% CO₂. In this embodiment, first and second feeds are of equal molar sizes. Remaining details are as per FIG. 1.

In the embodiment of FIG. 3, a system 100 similar to that of FIG. 2 is provided, in which reference numbers are as in FIG. 2. Additionally, the HER 20 has first 20B′ and second 20B″ heating sides. First product stream 11 is fed to first heating side 20B′, while second product stream 21 is fed to second heating side 20B″. A first cooled product stream is outlet from the first heating side 20B′ of the HER, while a second cooled product stream 32 is outlet from the second heating side 20B″.

In the embodiment of FIG. 4, a system 100 similar to that of FIG. 1 is provided, in which reference numbers are as in FIG. 1. Additionally, this system comprises a combustion unit 30 and a third feed 4 of fuel. The third feed 4 of fuel is arranged to be fed to the combustion unit 30 and combusted therein in the presence of an oxidant 4B (typically an O₂ stream) to provide a fifth feed 5 of combusted gas. Fifth feed 5 is fed to the heating side 20B of the HER as an additional source of heat.

FIG. 5 shows a system 100 similar to that of FIG. 4, in which first feed 1 and second feed 2 originate from the same primary feed 9 in the same manner as in the embodiment of FIG. 2.

The embodiment in FIG. 5A is based on the embodiment of FIG. 3. In this embodiment, the fifth feed 5 of combusted gas is passed through the heating side of the HER and the cooled fifth feed 25 is used downstream the HER as part of said first feed 1 comprising CO₂ and H₂ and/or as part of said second feed (2) comprising CO₂ and H₂. In the illustrated embodiment, a flash separator 40 is used to remove a stream of water 41, and the remainder of the fifth feed 25 is recycled to the primary feed 9.

The embodiment in FIG. 5A is based on the embodiment of FIG. 5B. In this embodiment, the first product stream 11 is combined with the second product stream 21, to form a third product stream, which is fed to the heating side of the HER.

### EXAMPLES

### Comparative Example 1

As a first example a comparative case is illustrated using a stand-alone e-RWGS reactor with a non-selective catalyst. The operation of this process is summarized in Table 1, where a total feed of 10000 Nm³/h containing 69.2% H₂ and 30.8% CO2 is converted into a synthesis gas with a H₂/CO ratio of 1.88 by using 3.21 GCal/h in the e-RWGS reactor, corresponding to 1340 kcal per Nm³ CO produced.

TABLE 1

| Stream | 1 | 11 |
|---|---|---|
| T [° C.] | 450 | 1050 |
| P [barg] | 11.5 | 10.0 |
| Flow [Nm³/h] | 10000 | 9988 |
| Composition | | |
| [mole %] | | |
| H2 | 69.2 | 45.1 |
| CO2 | 30.8 | 6.8 |
| N2 | 0.0 | 0.0 |
| CO | 0.0 | 24.0 |
| H2O | 0.0 | 24.1 |
| CH4 | 0.0 | 0.1 |

### Example 2

As a first example of the invention, a combination of a e-RWGS and a HER is illustrated in Table 2 for production of synthesis gas suitable for Fischer-Tropsch synthesis. In this case a primary feed of 10000 Nm³/h containing 69.2% H2 and 30.8% CO₂ is separated into a first and a second feed of equal molar sizes to be fed into respectively a e-RWGS and a HER. The stream from the e-RWGS again produces a synthesis gas with a H₂/CO ratio of 1.88 by heating and converting the gas according to thermodynamics to 1050° C. The HER is operated with an outlet temperature of 950° C. (as given partly by the available temperatures from the heating gases) and receives 50% of the molar flow from the primary feed (i.e. 50% of the combined molar flow of the first and second feed). The first and the second product streams are mixed as used as heating source for the HER which cools the gas to 646° C., i.e. leaving 196° C. of driving force for the heat exchange. Overall, the combined synthesis gas has a H₂/CO ratio of 1.94, which is slightly higher than the comparative example. However, this is also done using only 689 kcal per Nm³ CO, which is 49% reduced duty compared to the comparative example. Specifically, the duty required for e-RWGS is 1.6 Gcal/h, while the duty transferred to the process side of the HER is 1.4 Gcal/h and the HER thereby constitutes 46% of the total transferred duty to process side across the two reactors. This duty split roughly reflects split in CO production, where 49% of the CO production is done in the HER.

The carbon activity for the CO reduction reaction of the combined (i.e. third) cooled product gas is 6.2.

TABLE 2

| Stream | 1 | 2 | 11 | 21 | 35 |
|---|---|---|---|---|---|
| T [° C.] | 450 | 450 | 1050 | 950 | 646 |
| P [barg] | 11.5 | 11.5 | 10.0 | 10.0 | 9.5 |
| Flow [Nm³/h] | 5000 | 5000 | 4994 | 4968 | 9962 |
| Composition | | | | | |
| [mole %] | | | | | |
| H2 | 69.2 | 69.2 | 45.1 | 45.6 | 45.3 |
| CO2 | 30.8 | 30.8 | 6.8 | 7.9 | 7.3 |
| N2 | 0.0 | 0.0 | 0.0 | 0.0 | 0.0 |
| CO | 0.0 | 0.0 | 24.0 | 22.8 | 23.4 |
| H2O | 0.0 | 0.0 | 24.1 | 23.4 | 23.8 |
| CH4 | 0.0 | 0.0 | 0.1 | 0.3 | 0.2 |

### Example 3

In another example, a combination of an e-RWGS and a HER is illustrated in Table 3, illustrating how HER can be the principle CO producing unit. In this case a primary feed of Nm³/h containing 69.2% H₂ and 30.8% is separated into a first and a second feed of respectively 45% and 55% of the total molar flow. The stream from the e-RWGS again produces a synthesis gas with a H₂/CO ratio of 1.88 by heating and converting the gas according to thermodynamics to 1050° C. The HER is operated with an outlet temperature of 905° C. (as given partly by the available temperatures from the heating gases) and receives 55% of the molar flow from the primary feed (i.e. 55% of the combined molar flow of the first and second feed). The first and the second product streams are mixed as used as heating source for the HER which cools the gas to 621° C., i.e. leaving 171° C. of driving force for the heat exchange. Overall, the combined synthesis gas has a H₂/CO ratio of 1.98, which is slightly higher than the comparative example. However, this is also done using only 637 kcal per Nm³ CO, which is 52% reduced duty compared to the comparative example. Specifically, the duty required for e-RWGS is 1.4 Gcal/h, while the duty transferred to the process side of the HER is 1.3 Gcal/h and the HER thereby constitutes 48% of the total transferred duty to process side across the two reactors. This duty split roughly reflects split in CO production, where 52% of the CO production is done in the HER.

The carbon activity for the CO reduction reaction of the combined (i.e. third) cooled product gas is 73.

TABLE 3

| Stream | 1 | 2 | 11 | 21 | 35 |
|---|---|---|---|---|---|
| T [° C.] | 450 | 450 | 1050 | 905 | 621 |
| P [barg] | 11.5 | 11.5 | 10.0 | 10.0 | 9.5 |
| Flow [Nm³/h] | 4500 | 5500 | 4495 | 5420 | 9915 |
| Composition | | | | | |
| [mole %] | | | | | |
| H2 | 69.2 | 69.2 | 45.1 | 45.4 | 45.2 |
| CO2 | 30.8 | 30.8 | 6.8 | 8.6 | 7.8 |
| N2 | 0.0 | 0.0 | 0.0 | 0.0 | 0.0 |
| CO | 0.0 | 0.0 | 24.0 | 21.9 | 22.8 |
| H2O | 0.0 | 0.0 | 24.1 | 23.4 | 23.7 |
| CH4 | 0.0 | 0.0 | 0.1 | 0.7 | 0.4 |

### Example 4

In another example, a combination of a e-RWGS and a HER is illustrated in Table 4, illustrating how a HER operation can be configured with very low driving force for metal dusting. In this case a primary feed of 10000 Nm³/h containing 69.2% H₂ and 30.8% is separated into a first and a second feed of respectively 60% and 40% of the total molar flow. The stream from the e-RWGS again produces a synthesis gas with a H₂/CO ratio of 1.88 by heating and converting the gas according to thermodynamics to 1050° C. The HER is operated with an outlet temperature of 915° C. (as given partly by the available temperatures from the heating gases) and receives 40% of the molar flow from the primary feed (i.e. 40% of the combined molar flow of the first and second feed). The first and the second product streams are mixed as used as heating source for the HER which cools the gas to 737° C. Overall, the combined synthesis gas has a H₂/CO ratio of 1.95, which is slightly higher than the comparative example. However, this is also done using only 832 kcal per Nm³ CO, which is 38% reduced duty compared to the comparative example. Specifically, the duty required for e-RWGS is 1.9 Gcal/h, while the duty transferred to the process side of the HER is 1.0 Gcal/h and the HER thereby constitutes 34% of the total transferred duty to process side across the two reactors. This duty split roughly reflects split in CO production, where 38% of the CO production is done in the HER.

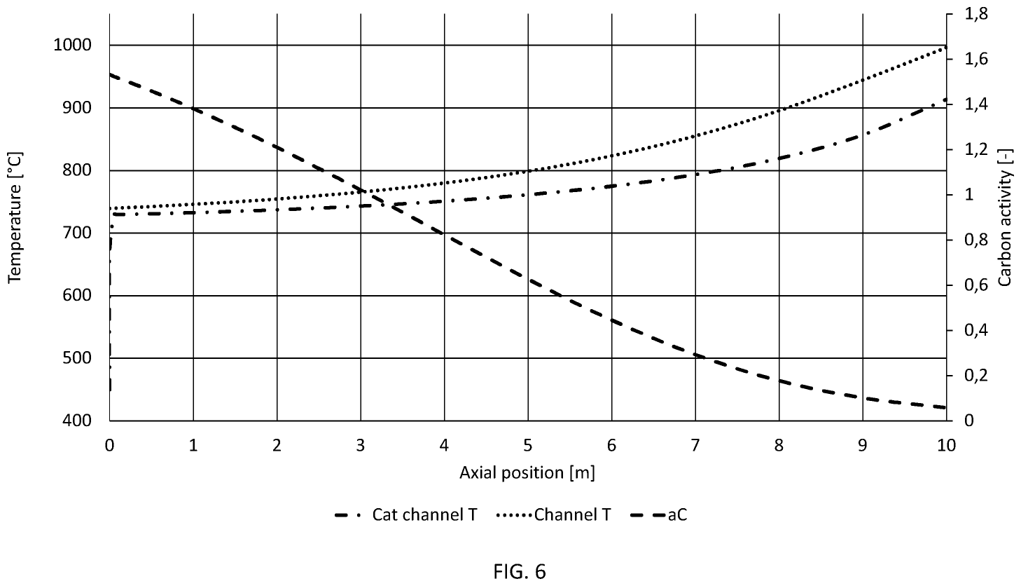

In the current configuration of the HER, it is utilized that the first reaction zone (1) of the HER is exothermic, which gives a high temperature rise on the process side and consequently also a lower temperature for cooling of the heating gas. This control means that the carbon activity cannot increase further. These details are explicitly illustrated by the temperature and actual gas carbon activity profile of the gas in the heating side of the HER illustrated in FIG. 8. Here it can be seen that the carbon activity for the CO reduction reaction does not exceed 1.6.

TABLE 4

| Stream | 1 | 2 | 11 | 21 | 35 |
|---|---|---|---|---|---|
| T [° C.] | 450 | 450 | 1050 | 915 | 738 |
| P [barg] | 11.5 | 11.5 | 10.0 | 10.0 | 9.5 |
| Flow [Nm³/h] | 6000 | 4000 | 5993 | 3952 | 9945 |
| Composition | | | | | |
| [mole %] | | | | | |
| H2 | 69.2 | 69.2 | 45.1 | 45.5 | 45.2 |
| CO2 | 30.8 | 30.8 | 6.8 | 8.4 | 7.4 |
| N2 | 0.0 | 0.0 | 0.0 | 0.0 | 0.0 |
| CO | 0.0 | 0.0 | 24.0 | 22.1 | 23.2 |
| H2O | 0.0 | 0.0 | 24.1 | 23.4 | 23.8 |
| CH4 | 0.0 | 0.0 | 0.1 | 0.6 | 0.3 |

In another example, a combination of a e-RWGS and a HER is illustrated in Table 5, illustrating how this configuration can be used to produce synthesis gas suitable for methanol production with a high content of CO. In this case a primary feed of 10000 Nm³/h containing 75% H₂ and 25% CO₂ is separated into a first and a second feed of respectively 60% and 40% of the total molar flow. The stream from the e-RWGS produces a synthesis gas with a H₂/CO ratio of 2.6 by heating and converting the gas according to thermodynamics to 1050° C. The HER is operated with an outlet temperature of 930° C. (as given partly by the available temperatures from the heating gases) and receives 40% of the molar flow from the primary feed (i.e. 40% of the combined molar flow of the first and second feed). The first and the second product streams are mixed as used as heating source for the HER which cools the gas to 750° C. Overall, the combined synthesis gas has a H₂/CO ratio of 2.68 and a module of 2.0 suitable for methanol production. This is also done using 899 kcal per Nm³ CO. Specifically, the duty required for e-RWGS is 1.8 Gcal/h, while the duty transferred to the process side of the HER is 0.9 Gcal/h and the HER thereby constitutes 34% of the total transferred duty to process side across the two reactors. This duty split roughly reflects split in CO production, where 38% of the CO production is done in the HER.

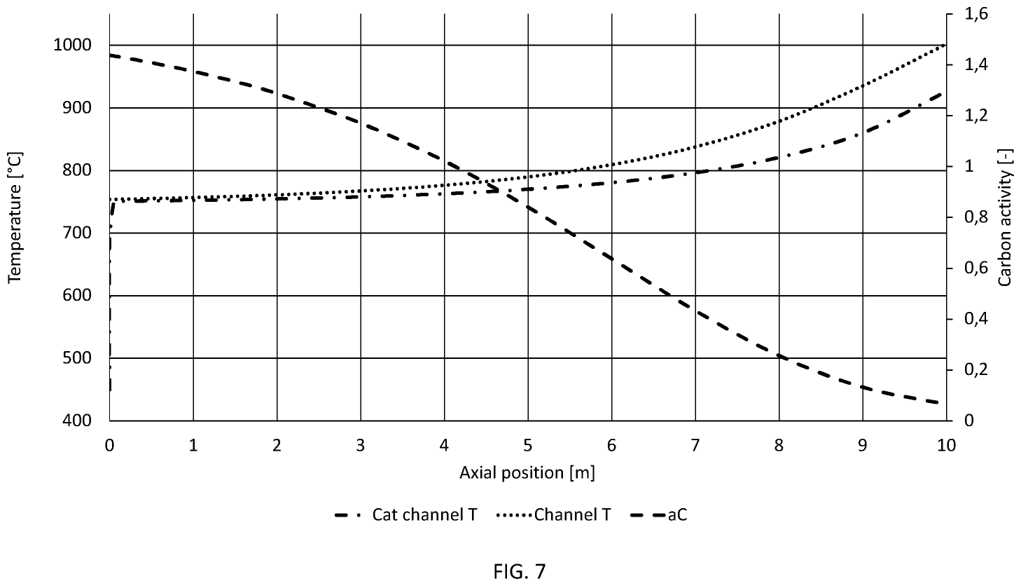

In the current configuration of the HER, it is utilized that the first reaction zone (I) of the HER is exothermic, which gives a high temperature rise on the process side and consequently also a lower temperature for cooling of the heating gas. This control means that the carbon activity cannot increase further. These details are explicitly illustrated by the temperature and actual gas carbon activity of the gas in the heating side of the HER in the given example illustrated in FIG. 9. Here it can be seen that the carbon activity for the CO reduction reaction does not exceed 1.5.

TABLE 5

| Stream | 1 | 2 | 11 | 21 | 35 |
|---|---|---|---|---|---|
| T [° C.] | 450 | 450 | 1050 | 930 | 750 |
| P [barg] | 11.5 | 11.5 | 10.0 | 10.0 | 9.5 |
| Flow [Nm³/h] | 6000 | 4000 | 5988 | 3941 | 9929 |
| Composition | | | | | |
| [mole %] | | | | | |
| H2 | 75.0 | 75.0 | 54.0 | 53.8 | 53.9 |
| CO2 | 25.0 | 25.0 | 4.2 | 5.3 | 4.7 |
| N2 | 0.0 | 0.0 | 0.0 | 0.0 | 0.0 |
| CO | 0.0 | 0.0 | 20.7 | 19.3 | 20.2 |
| H2O | 0.0 | 0.0 | 20.9 | 20.8 | 20.9 |
| CH4 | 0.0 | 0.0 | 0.1 | 0.7 | 0.4 |

### Example 6

In another example, a combination of a e-RWGS and a HER is illustrated in Table 5, illustrating how this configuration can be used to also process a primary feedstock containing methane. In this case a primary feed of 10000 Nm³/h containing 56.8% H₂, 22.7% CO₂, 11.4% CH₄, and 9.1% H₂O is separated into a first and a second feed of respectively 70% and 30% of the total molar flow. The stream from the e-RWGS produces a synthesis gas with a H₂/CO ratio of 2.37 by heating and converting the gas according to thermodynamics to 1050° C. The HER is operated with an outlet temperature of 912° C. (as given partly by the available temperatures from the heating gases) and receives 30% of the molar flow from the primary feed (i.e. 30% of the combined molar flow of the first and second feed). The first and the second product streams are mixed as used as heating source for the HER which cools the gas to 682° C. Overall, the combined synthesis gas has a H₂/CO ratio of 2.41. This is done using 1456 kcal per Nm³ CO, and part of the duty goes to the more endothermic reforming reaction. Specifically, the duty required for e-RWGS is 4.2 Gcal/h, while the duty transferred to the process side of the HER is 1.4 Gcal/h and the HER thereby constitutes 26% of the total transferred duty to process side across the two reactors. This duty split roughly reflects split in CO production, where 27% of the CO production is done in the HER.

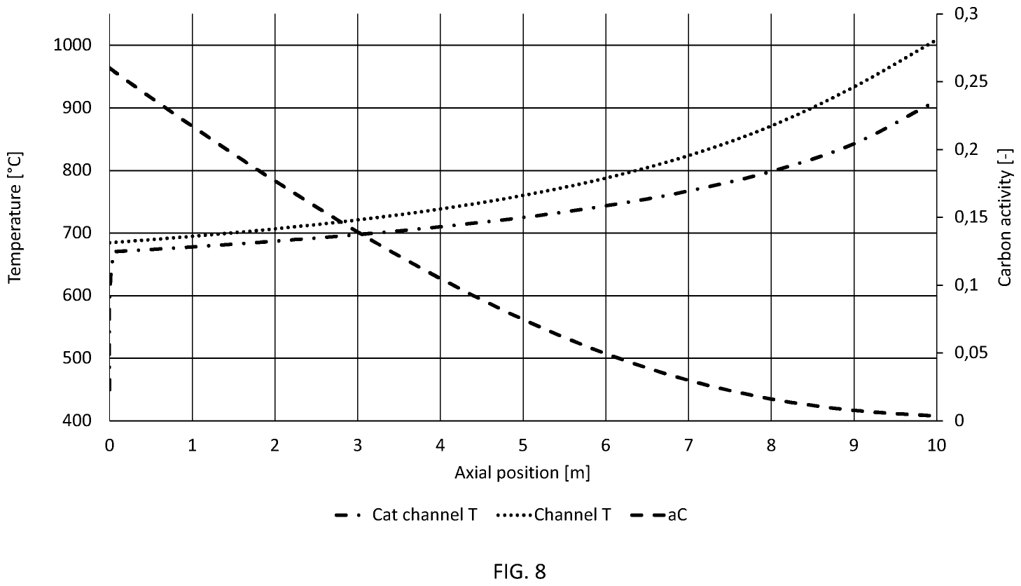

In the current configuration of the HER, it is utilized that the first reaction zone (I) of the HER is exothermic, which gives a high temperature rise on the process side and consequently also a lower temperature for cooling of the heating gas. This control means that the carbon activity cannot increase further. These details are explicitly illustrated by the temperature and actual gas carbon activity profile of the gas in the heating side of the HER in the given example illustrated in FIG. 10. Here it can see that the carbon activity for the CO reduction reaction does not exceed 0.3.

TABLE 5

| Stream | 1 | 2 | 11 | 21 | 35 |
|---|---|---|---|---|---|
| T [° C.] | 450 | 450 | 1050 | 912 | 682.53428 |
| P [barg] | 11.5 | 11.5 | 10.0 | 10.0 | 9.5 |
| Flow [Nm³/h] | 7000 | 3000 | 8553 | 3542 | 12095 |
| Composition | | | | | |
| [mole %] | | | | | |
| Hydrogen | 56.8 | 56.8 | 58.2 | 56.2 | 57.6 |
| Carbon Dioxide | 22.7 | 22.7 | 3.1 | 4.4 | 3.5 |
| Nitrogen | 0.0 | 0.0 | 0.0 | 0.0 | 0.0 |
| Methane | 11.4 | 11.4 | 0.2 | 2.0 | 0.7 |
| Water | 9.1 | 9.1 | 13.9 | 14.9 | 14.2 |
| Carbon Monoxide | 0.0 | 0.0 | 24.6 | 22.5 | 24.0 |

The present invention has been described with reference to a number of aspects and embodiments. These aspects and embodiments may be combined at will by the person skilled in the art while remaining within the scope of the patent claims.

1. A system for CO₂ shift, said system comprising:
a first feed comprising CO₂ and H₂,
a second feed comprising CO₂ and H₂,
a Reverse Water Gas Shift (RWGS) reactor, and
a heat exchange reactor, HER having at least a process side and at least a heating side,
wherein the first feed is arranged to be fed to the RWGS reactor and converted into a first product stream comprising CO;
wherein the second feed is arranged to be fed to a process side of the HER;
wherein at least a portion of the first product stream is arranged to be fed to a heating side of the HER such that heat from the first product stream is transferred to the process side of the HER, thereby allowing the conversion of the second feed to a second product stream comprising CO in the process side of the HER; and providing a cooled first product stream.

2. The system according to claim 1, wherein the RWGS reactor is selected from an electrical RWGS reactor, a fired RWGS reactor or an autothermal RWGS reactor.

3. The system according to claim 1, wherein the first and/or second feed comprises methane, wherein the first and/or second feed comprises up to 3 mole % methane.

4. The system according to claim 1, wherein the methane content in the first feed is higher than the methane content in the second feed.

5. The system according to claim 1, further comprising a primary feed comprising CO₂ and H₂, wherein said primary feed is arranged to be divided into at least said first feed comprising CO₂ and H₂, and said second feed comprising CO₂ and H₂.

6. The system according to claim 1, wherein the HER is a bayonet-type HER, and wherein at least a portion of the second product stream is arranged to be fed to the heating side of the HER to provide a second cooled product stream.

7. The system according to claim 1, wherein at least a portion of the second product stream is arranged to be fed to the heating side of the HER, in admixture with part or all of the first product stream, and whereby said HER is arranged to output a third product stream from the heating side thereof.

8. The system according to claim 1, further comprising a combustion unit and a third feed of fuel, wherein said third feed of fuel is arranged to be fed to the combustion unit and combusted therein in the presence of an oxidant to provide a fifth feed of combusted gas, wherein said fifth feed is arranged to be fed to the heating side of the HER, alone or in admixture with said first and/or said second product streams.

9. The system according to claim 8, wherein the oxidant in said combustion unit is substantially pure oxygen.

10. The system according to claim 8, wherein the third feed of fuel is a feed comprising hydrogen, and the fifth feed is feed comprising steam.

11. The system according to claim 8, wherein the third feed of fuel is a feed comprising methane, and the fifth feed is a feed comprising carbon dioxide and steam.

12. The system according to claim 11, wherein the cooled fifth feed is used downstream the HER as part of said first feed comprising CO₂ and H₂ and/or as part of said second feed comprising CO₂ and H₂.

13. The system according to claim 1, wherein the process side of the HER comprises a process side inlet and a process side outlet, wherein a first reaction zone is disposed closest to the process side inlet,
and a second reaction zone is disposed closest to the process side outlet,
wherein the first reaction zone is arranged to carry out an overall exothermic reaction of said second feed, wherein the overall exothermic reaction comprises at least the following reactions, which have a net progress from left to right: 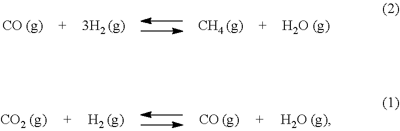
wherein the second reaction zone is arranged to carry out an overall endothermic reaction, wherein the overall endothermic reaction comprises at least the following reactions, which have a net progress from left to right:

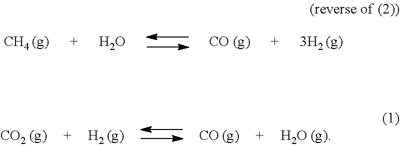

14. The system according to claim 13, wherein the process side of the HER has a total length extending from the process side inlet to the process side outlet, and wherein the first reaction zone has an extension of less than 50% of the total length of the process side of the HER.

15. The system according to claim 13, wherein a first catalyst is located at least in the first reaction zone.

16. The system according to claim 13, wherein at least the end of the first reaction zone which is located closest to the inlet of the HER is not directly in contact with the heating side of the HER, so that this end of the first reaction zone is primarily heated by the adiabatic temperature rise caused by said exothermic reaction.

17. The system according to claim 1, wherein the RWGS reactor is an electrical Reverse Water Gas Shift reactor or a fired RWGS reactor and wherein the HER is arranged to produce more than 20% of the total combined CO produced by the RWGS reactor and the HER.

18. The system according to claim 1, wherein the RWGS reactor is an electrical Reverse Water Gas Shift reactor or a fired RWGS reactor and wherein the system is arranged such that the molar flow of the second feed constitutes more than 20% of the total combined molar flow of the first and second feeds.

19. The system according to claim 1, wherein the RWGS reactor is an electrical Reverse Water Gas Shift reactor or a fired RWGS reactor and wherein the system is arranged such that the molar carbon flow of the second feed constitutes more than 20% of the total combined molar carbon flow of the first and second feeds.

20. A process for CO₂ shift, in a system according to claim 1, said process comprising the steps of:
feeding the first feed comprising CO₂ and H₂ to the RWGS reactor and converting it into a first product stream comprising CO;
feeding the second feed comprising CO, and H₂, to the process side of the HER;
arranging at least a portion of the first product stream to be fed to the heating side of the HER such that heat from the first product stream is transferred to the process side of the HER, thereby allowing the conversion of the second feed to a second product stream comprising CO in the process side of the HER; thus providing a cooled first product stream.

21. The process according to claim 20, wherein the RWGS reactor is selected from an electrical Reverse Water Gas Shift reactor, a fired RWGS reactor or an autothermal RWGS reactor.

22. The process according to claim 20, wherein the RWGS reactor is an electrical Reverse Water Gas Shift reactor or a fired RWGS reactor and wherein more than 20% of the total combined duty from the RWGS reactor and the HER can be placed in the HER.

23. The process according to claim 20, wherein the RWGS reactor is an electrical Reverse Water Gas Shift reactor or a fired RWGS reactor and wherein the HER produces more than 20% of the total combined CO produced by the RWGS reactor and the HER.

24. The process according to claim 20, wherein the RWGS reactor is an electrical Reverse Water Gas Shift reactor or a fired RWGS reactor and wherein the molar flow of the second feed constitutes more than 20% of the total combined molar flow of the first and second feeds.

25. The process according to claim 20, wherein the RWGS reactor is an electrical Reverse Water Gas Shift reactor or a fired RWGS reactor and wherein the molar carbon flow of the second feed constitutes more than 20% of the total combined molar carbon flow of the first and second feeds.

26. The process according to claim 20, wherein the process conditions are adjusted to provide a temperature of the cooled first product stream and/or the cooled second product stream and/or the cooled third product stream at the outlet of the HER which is higher than the critical limit for metal dusting.

27. The process according to claim 20, wherein the cooled exit temperature of the cooled first product stream and/or cooled second product stream and/or the cooled third product stream is 500° C. or higher.

28. The process according to claim 20, wherein the cooled first product stream and/or the cooled second product stream and/or the cooled third product stream at said cooled exit temperature has a CO reduction reaction actual gas carbon activity lower than 100.

29. The process according to claim 20, wherein the H₂/CO ratio of the first product gas, the second product gas, and/or the third cooled product stream is in the range from 0.5 to 3.0.

30. The process according to claim 20, wherein the (H₂−CO₂)/(CO+CO₂) ratio of the first product gas, the second product gas, and/or the third cooled product stream is in the range from 1.5 to 2.5.

31. A method for starting up the process according to claim 20, wherein the RWGS reactor is an electrical Reverse Water Gas Shift (e-RWGS) reactor, said method comprising the steps of:
a) introducing said first feed comprising CO₂ and H₂, to said RWGS reactor and converting it into a first product stream comprising CO; and allowing said at least a portion of the first product stream to be fed to the heating side of the H E R;
b) increasing the temperature of said first product stream by increasing the electrical power to said e-RWGS reactor;
c) feeding said second feed comprising CO₂ and H₂, to the process side of the HER wherein steps b and c are carried out after step a.

32. The method according to claim 31, wherein step b) is carried out after step c) or step c) is carried out after step b).

33. The method according to claim 31, wherein step c) is performed over a time period of 5 hours.
